(19) United States
(12) Patent Application Publication
(10) Pub. No.: US 2025/0028979 A1
(43) Pub. Date: Jan. 23, 2025

(54) Incident And Triggering Services Prediction

(71) Applicant: PagerDuty, Inc., San Francisco, CA (US)

(72) Inventors: Jung Soh, Calgary (CA); Everaldo Marques De Aguiar Junior, Seattle, WA (US)

(21) Appl. No.: 18/355,579

(22) Filed: Jul. 20, 2023

(51) Int. Cl. G06N 5/022

(52) U.S. Cl. CPC G06N 5/022

(57) ABSTRACT

In an aspect, a current state that includes incidents occurring in a lookback window is identified. Predicted incidents likely to occur in a prediction window based on the current state are identified. The predicted incidents are identified using a machine learning model that is trained to identify temporal associations between historically occurring incidents, a length of the lookback window, and a length of the prediction window. A notification is transmitted with respect to at least one of the predicted incidents. In another aspect, a current state that includes services that triggered incidents in a lookback window is identified. Predicted services likely to trigger incidents in a prediction window based on the current state are identified using a machine learning model that is trained to identify temporal associations between historically incident triggering services, a length of the lookback window, and a length of the prediction window.

### CROSS REFERENCE TO RELATED APPLICATIONS

This application relates to U.S. patent application Ser. No. 17/697,078, filed Mar. 17, 2022, the entire disclosure of which is incorporated herein by reference.

### TECHNICAL FIELD

This disclosure relates generally to computer operations and more particularly, but not exclusively to predicting incidents to be triggered and triggering services of the incidents.

### SUMMARY

A first aspect of the disclosed implementations is a method that includes identifying a current state comprising incidents occurring in a lookback window; identifying predicted incidents likely to occur in a prediction window based on the current state, where the predicted incidents are identified using a machine learning model that is trained to identify temporal associations between historically occurring incidents, a length of the lookback window, and a length of the prediction window; and transmitting a notification with respect to at least one of the predicted incidents. A second aspect of the disclosed implementations is a method that includes identifying a current state comprising of services that triggered incidents in a lookback window; identifying predicted services likely to trigger incidents in a prediction window based on the current state, where the predicted services are identified using a machine learning model that is trained to identify temporal associations between historically incident triggering services, a length of the lookback window, and a length of the prediction window; and transmitting a notification with respect to at least one of the predicted services. A third aspect of the disclosed implementations is a device that includes one or more memories and one or more processors. The one or more processors are configured to execute instructions stored in the one or more memories to identify a current state comprising incidents occurring in a lookback window; identify, using an incidents prediction model, predicted incidents likely to occur in a prediction window, where the incidents prediction model is trained to identify temporal associations between historically occurring incidents, a length of the lookback window, and a length of the prediction window; identify, using a services prediction model, predicted services likely to trigger the predicted incidents in the prediction window; and assign an incident triggered by one of the predicted services to a responder assigned to one of the incidents occurring in the lookback window. It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 shows components of one embodiment of a computing environment for event management.

FIG. 2 shows one embodiment of a client computer.

FIG. 3 shows one embodiment of a network computer that may at least partially implement one of the various embodiments.

FIG. 4 illustrates a logical architecture of an event management bus (EMB) for predicting incidents likely to be triggered and/or triggering services.

FIG. 5A is a block diagram of example functionality of a prediction software.

FIG. 5B is a diagram illustrating a process of training and using ML models for incident and service prediction.

FIG. 6A is a flowchart of a technique for selecting a lookback window and a prediction window.

FIG. 6B illustrates a plot of inter-arrival times (IATs).

FIG. 7 illustrates an example of identifying temporal association rules during a training phase of an ML model.

FIG. 8A illustrates an example of predicting which services will trigger incidents.

FIG. 8B illustrates an example of predicting which incidents will be triggered.

FIG. 9 is a block diagram of an example illustrating the operations of a template selector.

FIG. 10 illustrates examples of templates.

FIG. 11 is a flowchart of a technique for incident prediction.

FIG. 12 is a flowchart of a technique for service prediction.

### DETAILED DESCRIPTION

An event management bus (EMB) is a computer system that may be arranged to monitor, manage, or compare the operations of one or more organizations. The EMB may be configured to accept various events that indicate conditions occurring in the one or more organizations. The EMB may be configured to manage several separate organizations at the same time. Briefly, an event can simply be an indication of a state of change to a component of an organization, such as hardware, software, or an IT service (or, simply, service). An event can be or describe a fact at a moment in time that may consist of a single or a group of correlated conditions that have been monitored and classified into an actionable state. As such, a monitoring tool of an organization may detect a condition in the IT environment (e.g. such as the computing devices, network devices, software applications, etc.) of the organization and transmit a corresponding event to the EMB. Depending on the level of impact (e.g., degradation of a service), if any, to one or more constituents of a managed organization, an event may trigger (e.g., may be, may be classified as, may be converted into) an incident. As such, an incident may be an unplanned disruption or degradation of service.

A service can be any grouping of related computing (e.g., software) functionality and may perform automated tasks, may respond to software or hardware events, may listen for, and respond to requests to perform actions from other software, may listen for and respond to data requests from other software. Services may be accessed (e.g., invoked) via prescribed interfaces. A service can have at least one service owner. A service owner is an entity (e.g., a person, a team of people) responsible for maintaining, monitoring, or otherwise overseeing the service.

Non-limiting examples of events may include that a monitored operating system process is not running, that a virtual machine is restarting, that disk space on a certain device is low, that processor utilization on a certain device is higher than a threshold, that a shopping cart service of an e-commerce site is unavailable, that a digital certificate has or is expiring, that a certain web server is returning a 703 error code (indicating that web server is not ready to handle requests), that a customer relationship management (CRM) system is down (e.g., unavailable) such as because it is not responding to ping requests, and so on.

At a high level, an event may be received at an ingestion software of the EMB, accepted by the ingestion software, queued for processing, and then processed. Processing an event can include triggering (e.g., creating, generating, instantiating, etc.) a corresponding alert and a corresponding incident in the EMB, sending a notification of the incident to a responder (i.e., a person, a group of persons, etc.), and/or triggering a response (e.g., a resolution) to the incident. An alert (an alert object) may be created (instantiated) for anything that requires a human to perform an action. Thus, the alert may embody or include the action to be performed.

An incident associated with an alert may or may be used to notify the responder who can acknowledge (e.g., assume responsibility for resolving) and resolve the incident. An acknowledged incident is an incident that is being worked on but is not yet resolved. The user that acknowledges an incident may be said to claim ownership of the incident, which may halt any established escalation processes. As such, notifications provide a way for responders to acknowledge that they are working on an incident or that the incident has been resolved. The responder may indicate that the responder resolved the incident using an interface (e.g., a graphical user interface) of the EMB.

Incident response tends to be reactive. When an incident occurs, a workflow is typically triggered to address and mitigate the impact of the underlying condition(s) in the IT environment. This reactive approach involves predefined steps and actions aimed at containing the incident, investigating its root cause, and restoring normal operations. During an incident, IT operations are certainly affected until the incident is resolved. As such, it would be desirable to anticipate (e.g., predict) the occurrence of incidents so that steps can be taken to prevent the predicted incidents or at least to minimize or mitigate their negative impacts.

One approach to incident prediction may involve the collection of historical data regarding a metric of interest (e.g., server response times, memory usage on a server, database response time, etc.). The historical data can be used to train a model to predict values of the metric. When actual data starts to deviate (such as by a threshold value) from predicted values obtained from the trained model, an incident is predicted to occur with respect to the metric or a monitored component related to the metric. That is, when real time data deviates from the expected norms, an incident is predicted. However, since the metric is already deviating from the norm, then a negative condition must have already occurred with respect to some monitored component. Thus, such a prediction model cannot be said to anticipate an incident that has not yet occurred and may simply be an anomaly detection model.

Implementations according to this disclosure can predict services at risk of experiencing (e.g., triggering) an incident in the future (i.e., within a prediction window), can predict the type of incident (e.g., an incident template) likely to occur (e.g., to be triggered), or both. Machine-learning (ML) models are trained to learn past incident or service occurrence patterns that are then used for predicting likely future incidents or services.

For brevity, the disclosure herein may refer to the concept of “predicting incidents.” However, “predicting incidents” should be understood to encompass not only the prediction of a specific incident with an exact title but also the prediction of an incident of a certain type or an incident that aligns with (e.g., is associated with) a specific incident template. To illustrate using but a simple example, consider two incidents: the first incident is titled “HIGH CPU USAGE OF 80% DETECTED AT 12:30:02” and the second incident is titled “HIGH CPU USAGE OF 84% DETECTED AT 06:59:02”. A textual comparison of their titles would not classify the first and the second incidents as the same incident. However, both incidents can be considered identical or similar as they align with (or may be associated with) the incident template “HIGH CPU USAGE OF <percent> DETECTED AT <time>”. This template serves as a common denominator, indicating that both incidents are of the same type, despite the differences in their specific details.

A predicted incident (e.g., an incident of a certain type or associated with a certain template) can be predicted within a prediction window in response to determining that one or more incidents associated with the predicted incident having occurred within a lookback window. To illustrate, and without limitations, in response to determining (e.g., detecting) that incidents A and B having occurred within the last 5 minutes (e.g., the lookback window), then it may be predicted that incident C will occur within the next 10 minutes (e.g., the prediction window). As already mentioned, that an incident is predicted can include that an incident of a certain type or associated with a certain incident template is predicted.

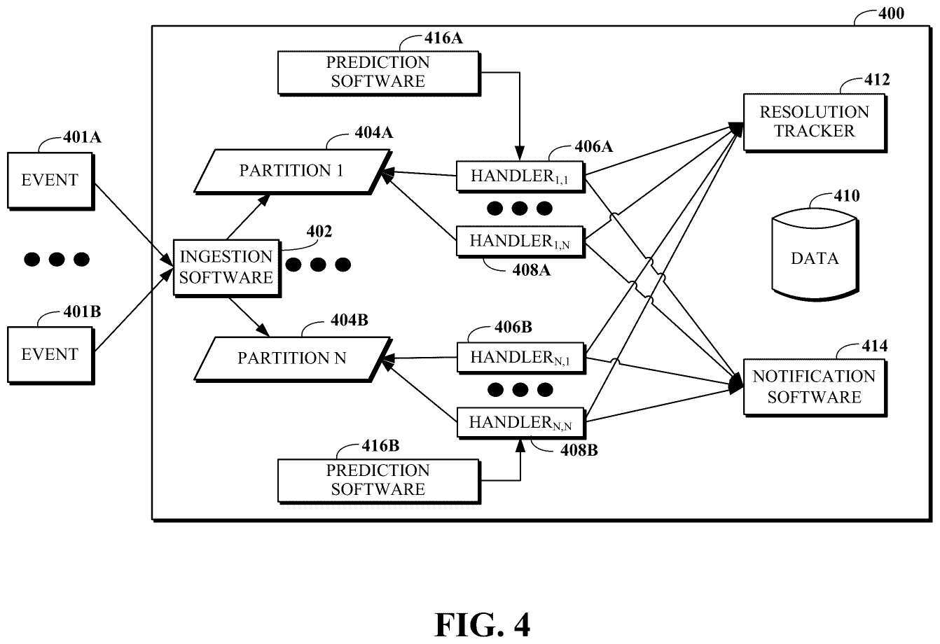

An incident may be triggered by a service. That is, an event received at the EMB with respect to the service may result in a handler (described with respect to FIG. 4) of the EMB instantiating the incident. The service is referred to herein as a triggering service. Implementations according to this disclosure can also predict that service S may trigger an incident within a prediction window in response to determining that one or more other services triggered respective incidents within a lookback window.

ML is used to train a model (referred to herein as an incidents prediction model) to extract association rules regarding the co-occurrence of incidents (e.g., incident types or templates). To illustrate, and as further described herein, the incidents prediction model can be trained to identify that if incident A occurs, then incident B is likely to occur within a prediction window. Accordingly, the incidents prediction model may be used to output notifications such as “incidents of templates T1, T2, . . . are likely in next X minutes.” In an example, each predicted incident can be associated with a confidence score that reflects the reliability of the prediction.

ML is also used to train another model (referred to herein as a services prediction model) to extract association rules regarding what services may trigger incidents within a prediction window given that one or more services have triggered incidents within a lookback window. Accordingly, the services prediction model may be used to output notifications such as “incidents on services S1, S2, . . . are likely in next X minutes.” In an example, each predicted service can be associated with a confidence score that reflects the reliability of the prediction.

When conditions in an IT environment are not detected until indications thereof are detected (such as described above with respect to detection of deviations from norms), significant resource utilization can result. This high usage can degrade the performance of the monitored IT environment and may even cause some operations to fail due to resource exhaustion. Frequent occurrences of such conditions can lead to degraded performance and increased resource usage. This often results in a substantial increase in investment in processing, memory, and storage resources to compensate for these conditions, which in turn can lead to increased energy expenditures required to operate these additional resources and associated emissions generated from this energy production. Thus, by predicting incidents before they occur, such additional resources and associated emissions can be avoided. Thus, proactively predicting incidents and services not only optimizes resource utilization but also contributes to energy efficiency and environmental sustainability.

Additionally, by predicting incidents (and their triggering services) before they occur, proactive steps can be taken to prevent the occurrence of such incidents. As such, events and alerts that would otherwise have caused handlers of the EMB to instantiate the incidents would not be received at, and therefore would not be processed by, the EMB. By avoiding the processing of these events and alerts, and not triggering incidents and their associated workflows, computational, storage, and network resources of the EMB can be conserved. This conservation of resources leads to a reduction in energy consumption that would otherwise be required for handling (for example, processing) such events, alerts, and incidents. As such, implementations according to this disclosure not only enhance the efficiency of the EMB but also contribute to energy conservation.

The term “organization” or “managed organization” as used herein refers to a business, a company, an association, an enterprise, a confederation, or the like.

The term “event,” as used herein, can refer to one or more outcomes, conditions, or occurrences that may be detected (e.g., observed, identified, noticed, monitored, etc.) by an event management bus. An event management bus (which can also be referred to as an event ingestion and processing system) may be configured to monitor various types of events depending on needs of an industry and/or technology area. For example, information technology services (IT services) may generate events in response to one or more conditions, such as, computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or combination thereof.

Events may be provided to the event management bus using one or more messages, emails, telephone calls, library function calls, application programming interface (API) calls, including, any signals provided to an event management bus indicating that an event has occurred. One or more third party and/or external systems may be configured to generate event messages that are provided to the event management bus.

The term “responder” as used herein can refer to a person or entity, represented or identified by persons, that may be responsible for responding to an event associated with a monitored application or service (collectively, IT services). A responder is responsible for responding to one or more notification events. For example, responders may be members of an information technology (IT) team providing support to employees of a company. Responders may be notified if an event or incident they are responsible for handling at that time is encountered. In some embodiments, a scheduler application may be arranged to associate one or more responders with times that they are responsible for handling particular events (e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a user or automated service. Typically, incidents may be a failure or error that occurs in the operation of a managed network and/or computing environment. One or more events may be associated with one or more incidents. However, not all events are associated with incidents.

The term “incident response” as used herein can refer to the actions, resources, services, messages, notifications, alerts, events, or the like, related to resolving one or more incidents. Accordingly, IT services that may be impacted by a pending incident, may be added to the incident response associated with the incident. Likewise, resources responsible for supporting or maintaining the IT services may also be added to the incident response. Further, log entries, journal entries, notes, timelines, task lists, status information, or the like, may be part of an incident response.

The term “notification message,” “notification event,” or “notification” as used herein can refer to a communication provided by an incident management system to a message provider for delivery to one or more responsible resources or responders. A notification event may be used to inform one or more responsible resources that one or more event messages were received. For example, notification messages may be provided to the one or more responsible resources using SMS texts, MMS texts, email, Instant Messages, mobile device push notifications, HTTP requests, voice calls (telephone calls, Voice Over IP calls (VOIP), or the like), library function calls, API calls, URLs, audio alerts, haptic alerts, other signals, or the like, or combination thereof.

The term “team” or “group” as used herein refers to one or more responders that may be jointly responsible for maintaining or supporting one or more IT services or system for an organization.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

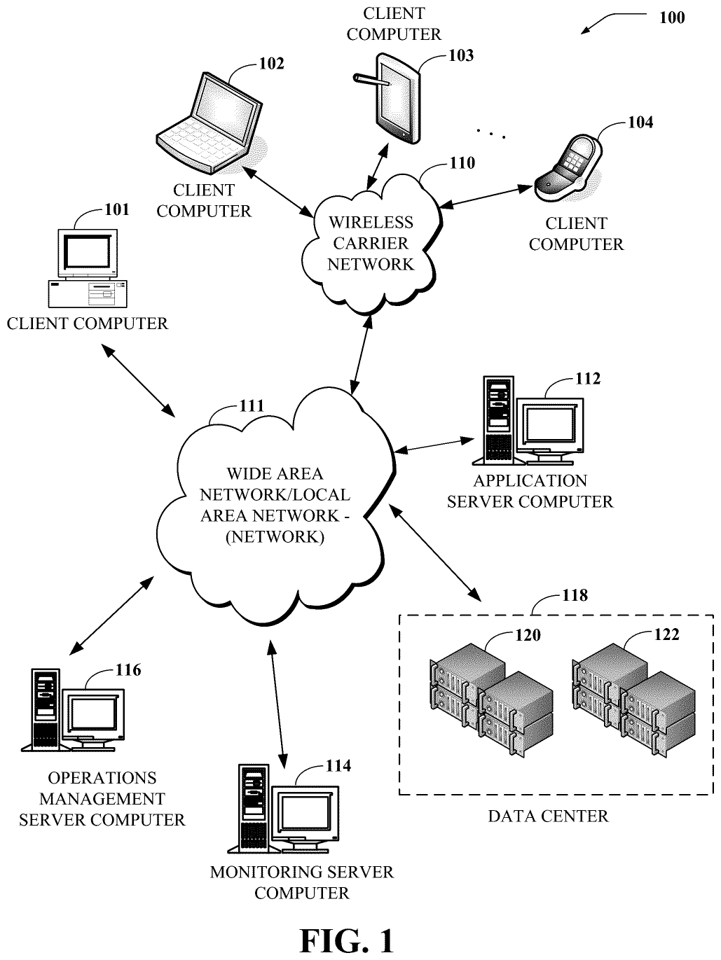

FIG. 1 shows components of one embodiment of a computing environment 100 for event management. Not all the components may be required to practice various embodiments, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IoT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one embodiment, one or more of the client computers 101-104 may be configured to operate within a business or other entity to perform a variety of IT services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other embodiments. Further, it should be recognized that more or less client computers may be included within a system such as described herein, and embodiments are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one embodiment, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), or the like. The wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. The network 111 can include any communication method by which information may travel between computing devices.

Additionally, communication media typically embodies computer-readable instructions, data structures, program modules, or other transport mechanisms and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

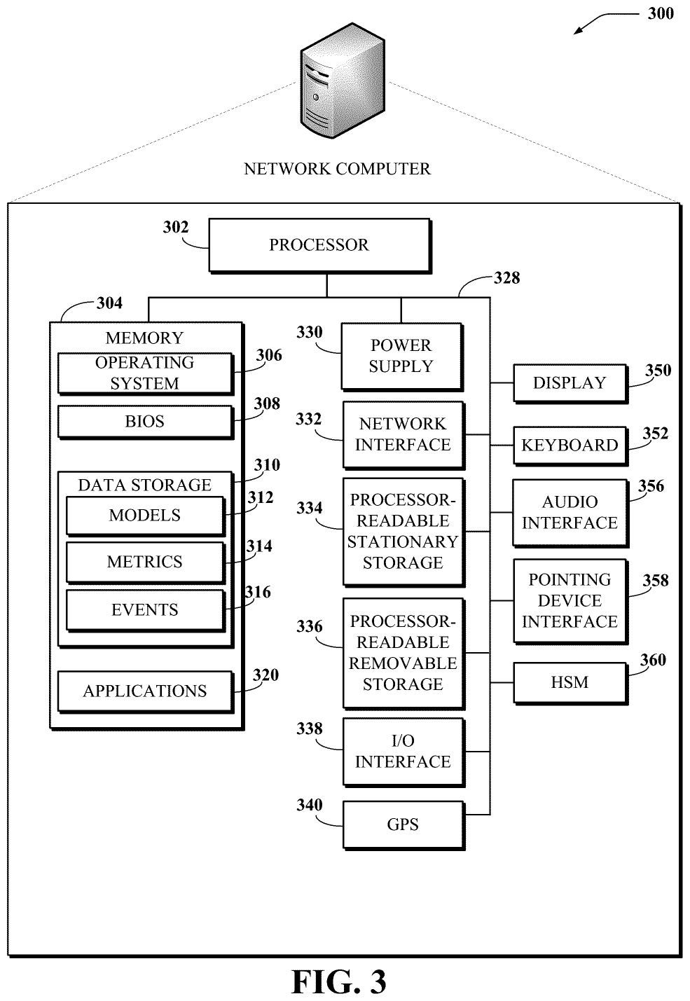

The operations management server computer 116 may include virtually any network computer usable to provide computer operations management services, such as a network computer, as described with respect to FIG. 3. In one embodiment, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

The monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some embodiments, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the invention is not so limited. Thus, the operations management server computer 116 may represent a plurality of network computers. For example, in one embodiment, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some embodiments, one or more data centers, such as a data center 118, may be communicatively coupled to the wireless network 110 and/or the network 111. The data center 118 may be a portion of a private data center, public data center, public cloud environment, or private cloud environment. In some embodiments, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some embodiments, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may vary depending on the demands of individual users, cloud network arrangement, operational loads, performance considerations, application needs, operational policy, or the like. The data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

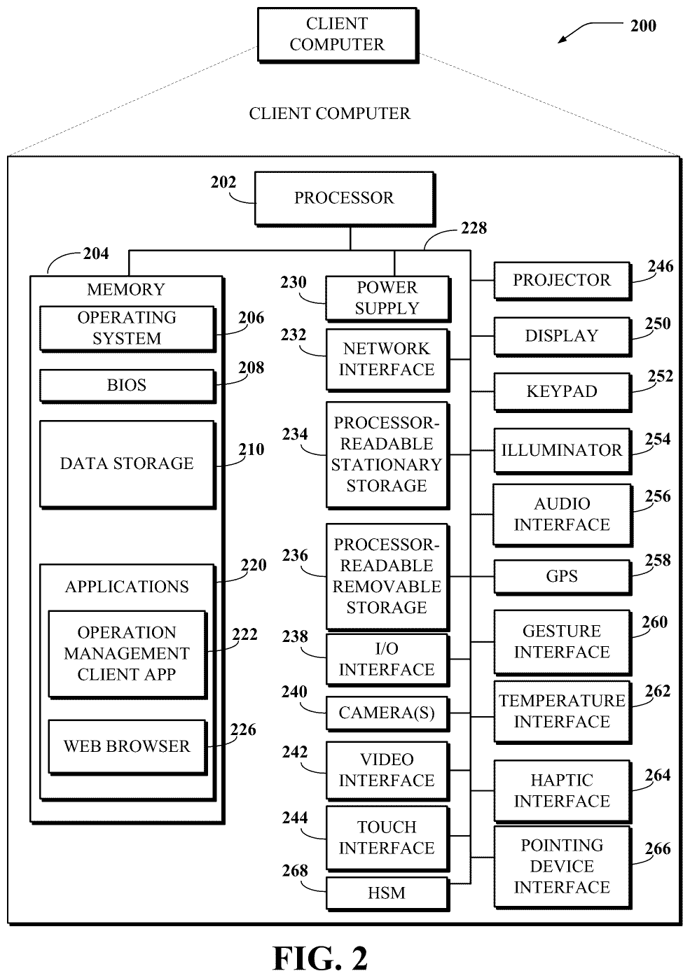

FIG. 2 shows one embodiment of a client computer 200. The client computer 200 may include more or less components than those shown in FIG. 2. The client computer 200 may represent, for example, at least one embodiment of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) transceiver 258, an open-air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one embodiment, although not shown, a gyroscope may be employed within the client computer 200 to measuring or maintaining an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open-air gesture interface 260 may sense physical gestures of a user of the client computer 200, for example, by using single or stereo video cameras, radar, a gyroscopic sensor inside a computer held or worn by the user, or the like. The camera 240 may be used to track physical eye movements of a user of the client computer 200.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one embodiment, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one embodiment, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. The operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the client computer 200 may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one embodiment of network computer 300 that may at least partially implement one of the various embodiments. The network computer 300 may include more or less components than those shown in FIG. 3. The network computer 300 may represent, for example, one embodiment of at least one EMB, such as the operations management server computer 116 of FIG. 1, the monitoring server computer 114 of FIG. 1, or an application server computer 112 of FIG. 1. Further, in some embodiments, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™ Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one embodiment, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one embodiment, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may be or include executable instructions, which can be loaded or copied, in whole or in part, from non-volatile memory to volatile memory to be executed by the processor 302. For example, the applications 320 can include instructions for performing some or all of the techniques of this disclosure. For example, the applications 320 can include software, tools, instructions or the like for training one or more ML models to mine temporal associations from historical incident data and to use the mined temporal associations to predict incidents and/or services. One or more of the applications may be implemented as modules or components of another application. Further, applications may be implemented as operating system extensions, modules, plugins, or the like.

Furthermore, at least some of the applications 320 may be operative in a cloud-based computing environment. These applications, and others, that include the management platform may be executing within virtual machines or virtual servers that may be managed in a cloud-based based computing environment. In this context the applications may flow from one physical network computer within the cloud-based environment to another depending on performance and scaling considerations automatically managed by the cloud computing environment. Likewise, Virtual machines or virtual servers dedicated to at least some of the applications 320 may be provisioned and de-commissioned automatically.

The applications may be arranged to employ geo-location information to select one or more localization features, such as, time zones, languages, currencies, calendar formatting, or the like. Localization features may be used in user-interfaces and well as internal processes or databases. Further, in some embodiments, localization features may include information regarding culturally significant events or customs (e.g., local holidays, political events, or the like). Geo-location information used for selecting localization information may be provided by the GPS transceiver 340. Also, in some embodiments, geolocation information may include information provided using one or more geolocation protocols over the networks, such as, the wireless network 108 or the network 111.

Also, at least some of the applications 320, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some embodiments, a hardware security module may be employed to support one or more standard public key infrastructures (PKI), and may be employed to generate, manage, or store keys pairs, or the like. In some embodiments, the HSM 360 may be a stand-alone network computer, in other cases, the HSM 360 may be arranged as a hardware card that may be installed in a network computer.

Additionally, in one or more embodiments (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 4 illustrates a logical architecture of an EMB 400 for predicting incidents likely to be triggered and/or triggering services. The EMB 400 may include various components. In this example, the EMB 400 includes an ingestion software 402, one or more partitions 404A-404B, one or more handlers 406A-406B and 408A-408B, a data store 410, a resolution tracker 412, a notification software 414, and prediction software 416A-416B. The data store 410 may not be included in the EMB 400.

One or more systems, such as monitoring systems, of one or more organizations may be configured to transmit events to the EMB 400 for processing. The EMB 400 may provide several handlers. A handler may, for example, process an event and determine whether a downstream object (e.g., an incident) is to be initiated (e.g., instantiated). As mentioned above, a received event may trigger an alert, which may trigger an incident, which in turn may cause notifications to be transmitted to responders.

A received event from an organization may include an indication of one or more handlers that are to operate on (e.g., process, etc.) the event. The indication of the handler is referred to herein as a routing key. A routing key may be unique to a managed organization. As such, two events that are received from two different managed organizations for processing by a same handler would include two different routing keys. A routing key may be unique to the handler that is to receive and process an event. As such, two events associated with two different routing keys and received from the same managed organization for processing may be directed to (e.g., processed by) different handlers.

The ingestion software 402 may be configured to receive or obtain different types of events provided by various sources, here represented by events 401A, 401B. The ingestion software 402 may be configured to accept or reject received events. In an example, events may be rejected when events are received at a rate that is higher than a configured event-acceptance rate. If the ingestion software 402 accepts an event, the ingestion software 402 may place the event in a partition (such as one of the partitions 404A, 404B) for further processing. If an event is rejected, the event is not placed in a partition for further processing. The ingestion software may notify the sender of the event of whether the event was accepted or rejected. Grouping events into partitions can be used to enable parallel processing and/or scaling of the EMB 400 so that the EMB 400 can handle (e.g., process, etc.) more and more events and/or more and more organizations (e.g., additional events from additional organizations).

The ingestion software 402 may be arranged to receive the various events and perform various actions, including, filtering, reformatting, information extraction, data normalizing, or the like, or combination thereof, to enable the events to be stored (e.g., queued, etc.) and further processed. The ingestion software 402 may be arranged to normalize incoming events into a unified common event format. Accordingly, in some embodiments, the ingestion software 402 may be arranged to employ configuration information, including, rules, maps, dictionaries, or the like, or combination thereof, to normalize the fields and values of incoming events to the common event format. The ingestion software 402 may assign (e.g., associate, etc.) an ingested timestamp with an accepted event.

An event may be stored in a partition, such as the partition 404A or the partition 404B. A partition can be, or can be thought of, as a queue (e.g., a first-in-first-out queue) of events. FIG. 4 is shown as including two partitions (i.e., the partitions 404A and 404B). However, the disclosure is not so limited and the EMB 400 can include one or more than two partitions.

In an example, different handlers of the EMB 400 may be configured to operate on events of the different partitions. In an example, the same handlers (e.g., identical logic) may be configured to operate on the accepted events in different partitions. To illustrate, in FIG. 4, the handlers 406A and 408A process the events of the partition 404A, and the handlers 406B and 408B process the events of partition the 404B, where the handler 406A and the handler 406B execute the same logic (e.g., perform the same operations) of a first handler but on different physical or virtual servers; and the handler 408A and the handler 408B execute the same logic of a second handler but on different physical or virtual servers. In an example, different types of events may be routed to different partitions. As such, each of the handlers 406A-406B and 408A-408B may perform different logic as appropriate for the events processed by the handler.

An (e.g., each) event, may also be associated with one or more handlers that may be responsible for processing the events. As such, an event can be said to be addressed or targeted to the one or more handlers that are to process the event. As mentioned above, an event can include or can be associated with a routing key that indicates the one or more handlers that are to receive the event for processing.

Events may be variously formatted messages that reflect the occurrence of events or incidents that have occurred in the computing systems or infrastructures of one or more managed organizations. Such events may include facts regarding system errors, warning, failure reports, customer service requests, status messages, or the like. One or more external services, at least some of which may be monitoring services, may collect events and provide the events to the EMB 400. Events as described above may be comprised of, or transmitted to the EMB 400 via, SMS messages, HTTP requests/posts, API calls, log file entries, trouble tickets, emails, or the like. An event may include associated metadata, such as, a title (or subject), a source, a creation time stamp, a status indicator, a region, more information, fewer information, other information, or a combination thereof, that may be tracked. In an example, the event data may be received as structured data, which may be formatted using JavaScript Object Notation (JSON), XML, or some other structured format. The metadata associated with an event is not limited in any way. The metadata included in or associated with an event can be whatever the sender of the event deems required.

The data store 410 may be arranged to store performance metrics, configuration information, or the like, for the EMB 400. In an example, the data store 410 may be implemented as one or more relational database management systems, one or more object databases, one or more XML databases, one or more operating system files, one or more unstructured data databases, one or more synchronous or asynchronous event or data buses that may use stream processing, one or more other suitable non-transient storage mechanisms, or a combination thereof.

Data related to events, alerts, incidents, notifications, other types of objects, or a combination thereof may be stored in the data store 410. For example, the data store 410 can include data related to resolved and unresolved alerts. For example, the data store 410 can include data identifying whether alerts are or are not acknowledged. For example, with respect to a resolved alert, the data store 410 can include information regarding the resolving entity that resolved the alert (and/or, equivalently, the resolving entity of the event that triggered the alert), the duration that the alert was active until it was resolved, other information, or a combination thereof. The resolving entity can be a responder (e.g., a human). The resolving entity can be an integration (e.g., automated system), which can indicate that the alert was auto-resolved. That the alert is auto-resolved can mean that the EMB 400 received, such as from the integration, an event indicating that a previous event, which triggered the alert, is resolved. The integration may be a monitoring system.

The data store 410 can include historical data. The historical data include triggered incidents, data indicating the services that triggered the incidents, data indicating the handlers that instantiated the incidents, and metadata associated therewith. For example, respective times that the incidents were triggered (e.g., instantiated) may be associated with the incidents. The data store 410 may include a catalogue (a list) of incident templates. An incident template may be associated with an incident. That an incident template is associated with an incident can include that an identifier of an incident template is associated with the incident. The identifier of an incident template can be a hash value generated from the incident template. For example, the incident template can be a textual string and a hash value may be generated, using any known technique, from the textual string.

While not specifically shown in FIG. 4, the EMB 400 may include a component-extraction tool. The component-extraction tool may identify a service based on data associated with an event (e.g., a service identifier, a title, or a payload of the alert). Identifying a service associated with an event, as used herein, includes identifying the service based on the event. The EMB may store or access information correlating a service to at least one entity that owns the service. The entity that owns a service can be identified by the EMB by looking up the service in the information and returning the identity of the entity correlated to the service. The EMB may use the identity of the service owners to send alerts and other messages related to the events to the service owners. U.S. patent application Ser. No. 17/697,078 provides further details on identifying services, IT components, and responders associated with an event.

The incident templates stored in the data store 410 can be used by a template selector (such as a template selector of the prediction software 416A or the prediction software 416B). The template data can be used to identify (e.g., select, choose, infer, determine, etc.) a template for an incident. The data store 410 can be used to store an association between the incident and the identified template. In an example, an identifier of the identified template can be stored as metadata of the incident. As such, the data store 410 can include historical data of incidents and corresponding incident templates.

The resolution tracker 412 may be arranged to monitor the details regarding how events, alerts, incidents, other objects received, created, managed by the EMB 400, or a combination thereof are resolved. In some embodiments, this may include tracking incident and/or alert life-cycle metrics related to the events (e.g., creation time, acknowledgement time(s), resolution time, processing time,), the resources that are/were responsible for resolving the events, the resources (e.g., the responder or the automated process) that resolved alerts, and so on. The resolution tracker 412 can receive data from the different handlers that process events, alerts, or incidents. Receiving data from a handler by the resolution tracker 412 encompasses receiving data directly from the handler and/or accessing (e.g., polling for, querying for, asynchronously being notified of, etc.) data generated (e.g., set, assigned, calculated by, stored, etc.) by the handler. The resolution tracker can receive (e.g., query for, read, etc.) data from the data store 410. The resolution tracker can write (e.g., update, etc.) data in the data store 410.

While FIG. 4 is shown as including one resolution tracker 412, the disclosure herein is not so limited and the EMB 400 can include more than one resolution tracker. In an example, different resolution trackers may be configured to receive data from handlers of one or more partitions. In an example, each partition may have associated with one resolution tracker. Other configurations or mappings between partitions, handlers, and resolution trackers are possible.

The notification software 414 may be arranged to generate notification messages for at least some of the accepted events. The notification messages may be transmitted to responders (e.g., responsible users, teams) or automated systems. The notification software 414 may select a messaging provider that may be used to deliver a notification message to the responsible resource. The notification software 414 may determine which resource is responsible for handling the event message and may generate one or more notification messages and determine particular message providers to use to send the notification message.

A scheduler (not shown) may determine which responder is responsible for handling an incident based on at least an on-call schedule and/or the content of the incident. The notification software 414 may generate one or more notification messages and determine a particular message for providers to use to send the notification message. Accordingly, the selected message providers may transmit (e.g., communicate, etc.) the notification message to the responder. Transmitting a notification to a responder, as used herein, and unless the context indicates otherwise, encompasses transmitting the notification to a team or a group. In some embodiments, the message providers may generate an acknowledgment message that may be provided to EMB 400 indicating a delivery status of the notification message (e.g., successful or failed delivery).

The notification software 414 may determine the message provider based on a variety of considerations, such as, geography, reliability, quality-of-service, user/customer preference, type of notification message (e.g., SMS or Push Notification, or the like), cost of delivery, or the like, or combination thereof. Various performance characteristics of each message provider may be stored and/or associated with a corresponding provider performance profile. Provider performance profiles may be arranged to represent the various metrics that may be measured for a provider. Also, provider profiles may include preference values and/or weight values that may be configured rather than measured,

The EMB 400 may include various user-interfaces or configuration information (not shown) that enable organizations to establish how events should be resolved. Accordingly, an organization may define rules, conditions, priority levels, notification rules, escalation rules, routing keys, or the like, or combination thereof, that may be associated with different types of events. For example, some events (e.g., of the frequent type) may be informational rather than associated with a critical failure. Accordingly, an organization may establish different rules or other handling mechanics for the different types of events. For example, in some embodiments, critical events (e.g., rare or novel events) may require immediate (e.g., within the target lag time) notification of a response user to resolve the underlying cause of the event. In other cases, the events may simply be recorded for future analysis.

In an example, one or more of the user interfaces may be used to associate runbooks with certain types of objects. A runbook can include a set of actions that can implement or encapsulate a standard operating procedure for responding to (e.g., remediating, etc.) events of certain types. Runbooks can reduce toil. Toil can be defined as the manual or semi-manual performance of repetitive tasks. Toil can reduce the productivity of responders (e.g., operations engineers, developers, quality assurance engineers, business analysts, project managers, and the like) and prevents them from performing other value-adding work. In an example, a runbook may be associated with a template. As such, if an object matches the template, then the tasks of the runbook can be performed (e.g., executed, orchestrated, etc.) according to the order, rules, and/or workflow specified in the runbook. In another example, the runbook can be associated with a type. As such, if an object is identified as being of a certain type, then the tasks of the runbook associated with the certain type can be performed. A runbook can be assembled from predefined actions, custom actions, other types of actions, or a combination thereof.

In an example, one or more of the user interfaces may be used by responders to obtain information regarding objects and/or groups of objects. For example, a responder can use one of the user interfaces to obtain information regarding incidents assigned to or acknowledged by the responder. A user interface can be used to obtain information about an incident including the events (i.e., the group of events) associated with the incident. In an example, the responder can use the user interface to obtain information from the EMB 400 regarding the reason(s) a particular event was added to the group of events.

At least one of the handlers 406A-406B and 408A-408B may be configured to trigger alerts. A handler can also trigger an incident from an alert, which in turn can cause notifications to be transmitted to one or more responders.

The EMB 400 is shown as including two prediction software (i.e., the prediction software 416A-416B) where the prediction software 416A, 416B are associated with the handlers 406A, 408B, respectively. However, other arrangements (e.g., configurations, etc.) are possible and the disclosure is not limited to the configuration shown in FIG. 4. For example, the EMB 400 may include one or more than two prediction software. For example, each of the handlers of the EMB 400 can be associated with its respective prediction software. For example, more than one handler may be associated with a respective prediction software. For example, a respective prediction software can be available for, or associated with, one or more routing keys or one or more managed organizations.

That a prediction software is associated with a handler can mean or include that the handler may include the prediction software (e.g., includes the logic, instructions, tools, etc. performed by the prediction software). That a prediction software is associated with one or more handlers can mean that the prediction software can receive or access incident data of incidents created (e.g., triggered) by the one or more handlers (within a lookback window) and may predict which future incidents may be triggered (within a future prediction window). That a prediction software is associated with one or more handlers can mean that the prediction software can receive or access incident data of incidents created (e.g., triggered) by the one or more handlers (within a lookback window) and may predict which handlers are likely to trigger incidents in the future (i.e., within a future prediction window).

The prediction software can be associated with a handler in other ways. For example, alternatively or additionally, a prediction software may be configured to asynchronously receive notifications when incidents are created, such as, for example, when new incidents are stored in the data store 410, when a handler instantiates (e.g., creates, write to memory, etc.) an incident, or the like.

The prediction software can also access data relating to triggering services, which indicate which services triggered incidents and timestamps corresponding thereto. In an example, the prediction software may derive the data relating to the triggering services from incident data. For example, an incident may be associated with one or more services that triggered the incident. As such, given an incident, the prediction software can obtain the triggering service.

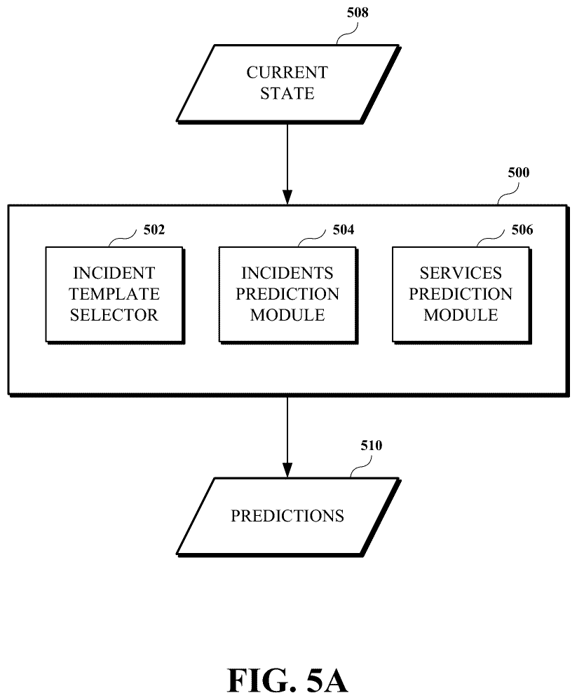

FIG. 5A is a block diagram of example functionality of a prediction software 500. The prediction software 500 can be one of the prediction software 416A or 416B of FIG. 4. The prediction software 500 includes tools, such as programs, subprograms, functions, routines, subroutines, operations, executable instructions, machine-learning models, and/or the like for, inter alia and as further described below, predicting which incidents may be triggered in a prediction window and/or which services may trigger incidents in the prediction window.

At least some of the tools of the prediction software 500 can be implemented as respective software programs that may be executed by one or more network computers, such as the network computer 300 of FIG. 3. A software program can include machine-readable instructions that may be stored in a memory such as the processor-readable stationary storage device 334 or the processor-readable removable storage device 336 of FIG. 3, and that, when executed by a processor, such as processor 302, may cause the network computer to perform the instructions of the software program.

The prediction software 500 is shown as including an incident template selector 502, an incidents prediction module 504, and a services prediction module 506. In some implementations, the incident template selector 502 may not be included in the prediction software 500. As such, the prediction software 500 may work in conjunction with (e.g., use) an incident template selector that is otherwise included or available in the EMB 400.

The prediction software 500 receives a current state 508 and outputs predictions 510. The predictions 510 are generated based on the current state 508. The current state 508 can be or include incidents that were triggered in (i.e., within or during) a lookback window (i.e., a lookback time window). The current state 508 can be or include, alternatively or additionally, data related to triggering services. However, as described above, the prediction software 500 may obtain the data related to the triggering services via incident data.

The current state 508 can be or include data usable by the incidents prediction module 504 and/or the services prediction module 506. The current state 508 can be or include incidents triggered in a lookback window (further described with respect to FIG. 5B). Receiving the current state 508 includes that the prediction software 500 accesses the current state from a data store, such as the data store 410 of FIG. 4. In the case that the incident template data is not associated with the current state, the incident template selector 502 can be used to identify incident templates associated with the incidents of the current state.

With respect to the incidents prediction module 504, the predictions 510 can be incidents (e.g., incident templates) that are likely to be triggered in (e.g., within, during) the prediction window. With respect to the services prediction module 506, the predictions 510 can be services, such as one or more handlers 406A-406B and 408A-408B of FIG. 4, that are likely to trigger incidents (i.e., incidents associated with certain templates) in (e.g., within or during) the prediction window. In the case of predicting services, the current state 508 can be the services that triggered incidents in the lookback window. Alternatively, the prediction software 500 can identify such services based on the triggered incidents included in the current state 508. The services prediction module 506 identifies connections or dependencies amongst services.

Each of the incidents prediction module 504 and the services prediction module 506 can be or include a respective ML model that is trained to identify (e.g., extract, infer, mine for) temporal associations that are then used for prediction. Training and using the respective ML models is further described with respect to FIG. 5B.

In an example, the prediction software 500 may include a handlers prediction module. The handler prediction module can be or include an ML model that is trained, as described herein with respect to the incidents prediction module 504 and the services prediction module 506, to predict which handlers are likely to instantiate incidents in a prediction window. Whereas the incidents prediction module 504 is trained using historical incident data and the services prediction module 506 is trained using historical triggering services data, the handlers prediction module can be trained using data related to the handlers that instantiated incidents.

FIG. 5B is a diagram illustrating a process 550 of training and using ML models for incident and service prediction. The process 550 illustrates a timeline 552 along which incidents may be triggered by an EMB, which can be the EMB 400 of FIG. 4.

Historical data 554 up to a time point 556 are used by a training phase 558 to train a prediction model 560. The prediction model 560 can be the incidents prediction module 504 or the services prediction module 506 of FIG. 5A. The historical data 554 can be data of one organization. As such, the EMB 400 of FIG. 4 can include respective ML models for different organizations. An ML model includes or uses a set of mined temporal association rules, the logic (e.g., executable instructions) to mine for such temporal association rules in historical incident data, and the logic to process (e.g., reason about, generate predictions based on) these mined temporal association rules.

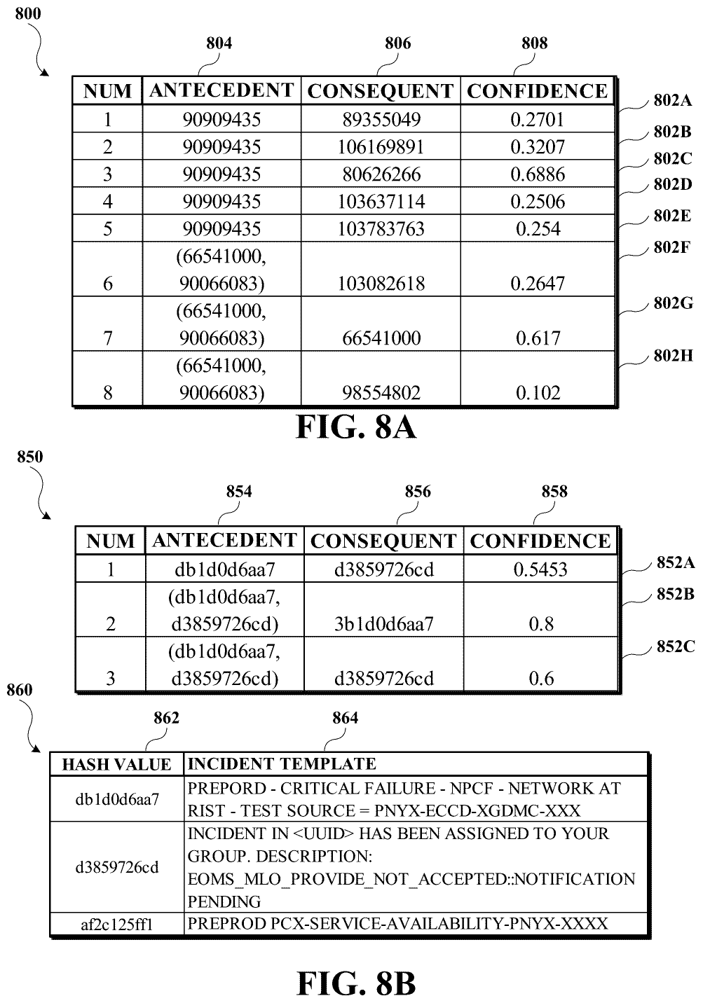

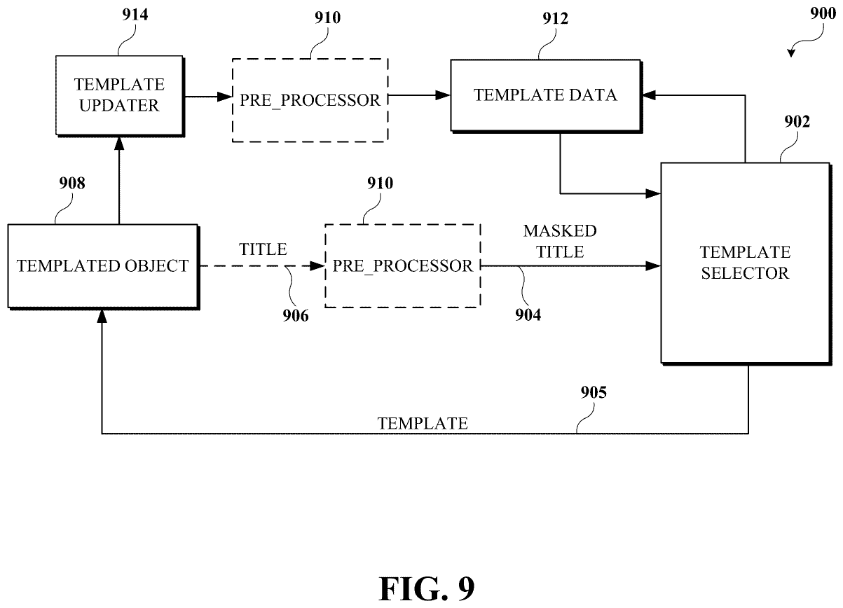

The historical data 554 can include incidents triggered up to the time point 556. The historical data 554 can include services that triggered the incidents. The incidents can be or include incident types (e.g., incident templates). Obtaining incident templates from incidents can be as described with respect to FIGS. 9-10.

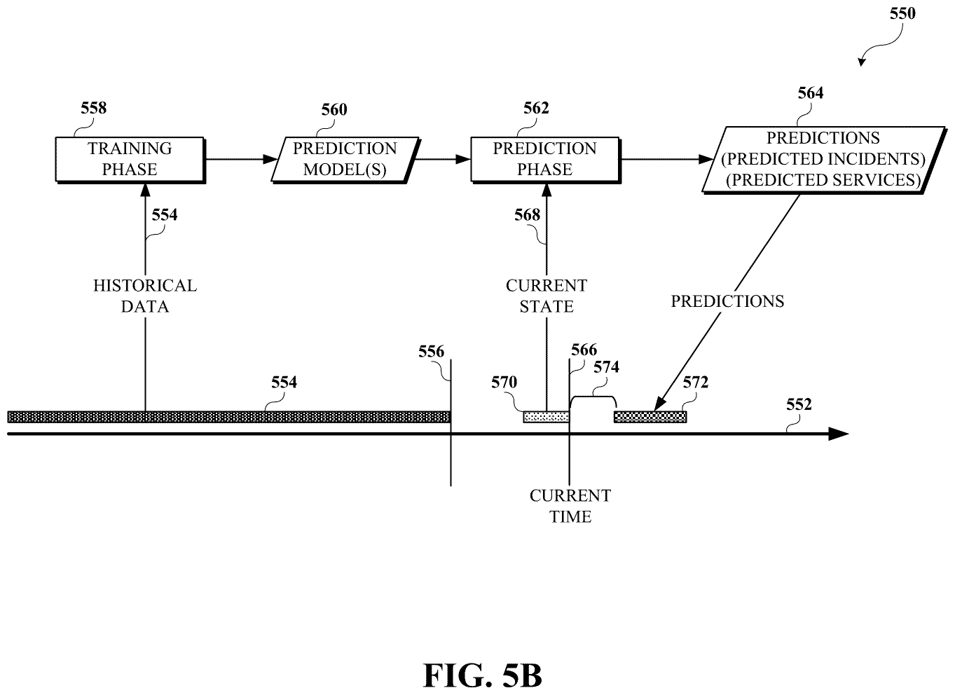

As mentioned, the prediction model 560 can be an incidents prediction model or a services prediction model. The prediction model 560 can be a handlers prediction module. As mentioned above, if the prediction model 560 is an incidents prediction model, then the prediction model 560 is trained to predict future incidents (e.g., future incident templates); and if the prediction model 560 is the services prediction model, then the prediction model 560 is trained to predict which services will trigger the incident templates. By “future” is meant within a “prediction window” (e.g., a future time window). Training the prediction model 560 is further described with respect to FIGS. 6-8B.

The prediction model 560 can then be used during a prediction phase 562 (e.g., an inference phase). During the prediction phase 562, the prediction model 560 is used to generate predictions 564. The predictions 564 can be generated at a current time 566. A current state 568 is used during the prediction phase 562 as input to the prediction model 560. The current state 568 can include the incidents (or incident templates) triggered within a lookback window 570 from the current time 566. The predictions 564 are predicted to occur in a prediction window 572, which may not immediately follow the current time 566. That is, there could be a hold time 574 between the lookback window 570 and the prediction window 572. The lengths of the lookback window 570 and the prediction window 572 can be determined during the training phase 558, as further described with respect to FIGS. 6A-6B.

The length of the hold time 574 may be pre-configured and may be changeable by an authorized user (e.g., an administrator). The hold time 574 may be set to zero. The hold time 574 may be used to provide responders with the opportunity to effectively deal with predictions. To illustrate, if the predicted incidents were likely to occur very soon (e.g., in less than two minutes), then responders might not be able to act on the prediction results therewith limiting the usefulness of the predictions. The hold time 574 may be pre-configured to 5 minutes (or some other default value). As such, if the prediction window 654 was calculated to be 14 minutes in length, the actual prediction window would be between 5 and 19 minutes from a current time (e.g., the current time 566). However, as already mentioned, an authorized user can decrease or increase the hold time duration. Reducing the hold time 574 to zero (0) effectively removes the hold time altogether between the lookback window 570 and the prediction window 572.

The predictions 564 can be generated at regular intervals (e.g., every 5 seconds) to provide timely and up-to-date predictions. In an example, the regular interval can be equal in length to the lookback window 570. The predictions 564 can be one of predicted future incidents (i.e., incidents that are likely to be triggered in the prediction window 572) or predicted future services (i.e., services that are likely to trigger incidents in the prediction window 572).

FIG. 6A is a flowchart of a technique 600 for selecting a lookback window and a prediction window. The technique 600 is described with reference to FIG. 6B, which illustrates a plot 650 of inter-arrival times (IATs). The technique 600 automatically selects (e.g., determines, sets, etc.) the lookback window and the prediction window based on historical interarrival data. As such, values for the lookback window and the prediction window need not be obtained from a human (e.g., an administrator). The human may not be able determine (e.g., identify) what are the optimal values for such parameters and may end up guessing therewith leading to suboptimal prediction performance. To illustrate, too large a value for the prediction window provided by the human may result in too much noise (e.g., too many predictions that are not likely to materialize; and too small a value for the lookback window provided by the human may result in too many, and faulty learned association rules.

The technique 600 can be implemented, for example, as a software program that may be executed by a computing device such as the network computer 300 of FIG. 3. The software program can include machine-readable instructions that may be stored in a memory such as one or more of the memory 304, the processor-readable stationary storage device 334, or the processor-readable removable storage device 336 of FIG. 3, and that, when executed by a processor, such as the processor 302 of FIG. 3, may cause the computing device to perform the technique 600. The technique 600 can be implemented using specialized hardware or firmware. Multiple processors, memories, or both, may be used.

At 602, historical training data are obtained. The historical training data can be the historical data 554 of FIG. 5. At 604, interarrival times are identified. With respect to incidents, the interarrival times are indicative of the frequency of incoming (e.g., triggered) incidents. With respect to services, the interarrival times are indicative of the frequency of triggering of incidents by services. In an example, the technique 600 can obtain the plot 650 (e.g., a histogram) of FIG. 6B. It is noted that the plot or histogram may not necessarily be a visual object. Rather, the plot 650 can be any data structure that can be used to represent the frequencies of the IATs.

With respect to incidents, an IAT is the hold time between the triggering of two incidents. In an example, each incident may include metadata indicative of its triggering or instantiation time. Thus, the IAT between two incidents can be calculated as the absolute difference between such metadata. A respective IAT is calculated for each pair of incidents where no incidents are triggered between the incidents of the pair of incidents. Thus, in an example, the historical training data may be sorted, such as in ascending order of creation times of the incidents included in the historical training data. IATs are calculated for each pair of consecutive incidents in the sorted list.

With respect to services, an IAT is the time gap between the triggering by services of incidents. The arrival times for services can be obtained from the triggered incidents. To illustrate, given a pair of incidents that includes a first incident and a second incident where the first incident is triggered by a first service and the second incident is triggered by a second service, then the IAT between the pair of incidents can be used as an IAT between the first service and the second service. It is noted that the first service and the second service may be the same service. In an example, the IATs can be obtained from events that caused the incidents to be triggered. In an example, events may include timestamp data that can be used as arrival times. In an example, arrival times of events can be the times that the ingestion software 402 of FIG. 4 received the events.

Referring again to FIG. 6A, at 606, the lookback window can be selected based on the IATs; and at 608, the prediction window can be selected based on the IATs. On the one hand, if the IATs tend to be long, then there may not be many incidents in a given amount of time. On the other hand, if the IATs tend to be small, then there may be many incidents in a small amount of time. As such, the IATs can be useful in setting the lengths of the prediction window and the lookback window. In FIG. 6B, a lookback window 652 is illustrated as being selected based on the IATs; and a prediction window 654 is illustrated as being selected based on the IATs. The hold time 656 can be set as described above with respect to the hold time 574 of FIG. 5B.

Selecting the lookback window 652 based on the IATs can include setting the lookback window 652 based on a first selected percentile distribution of the IATs. In an example, the length of the lookback window can be set based on the p50 (50^{th} percentile or the median of the IATs). By utilizing the median, the prediction model focuses on a balanced lookback period without excessively relying on distant historical data. Selecting the lookback window based on the median can have the effect that the prediction model takes recent incidents into account while maintaining a reasonable timeframe for analysis therewith striking a balance between capturing relevant past patterns and avoiding excessive reliance on potentially outdated or less relevant data.

Selecting the prediction window 654 based on the IATs can include selecting a specific percentile distribution. For instance, setting the prediction window 654 based on the second selected percentile distribution of the IATs can be considered. As an example, the length of the prediction window can be set using p75 (75^{th} percentile of the IATs). By utilizing the 75^{th} percentile, the prediction model can be designed to forecast (predict) a few incidents (e.g., no more than 2 to 5 incidents), therewith striking a balance between providing valuable predictions without generating excessive, noisy, and potentially inaccurate predictions.

The selection of an appropriate percentile for the prediction window is crucial in optimizing the balance between prediction accuracy and noise. Setting the prediction window too wide by utilizing a larger percentile could result in an excessive number of predictions, potentially inundating the incident responders with false alarms and decreasing the overall accuracy of the predictions. Therefore, careful consideration of the percentile distribution helps ensure the prediction window is set at an optimal length for reliable incident forecasting.

The prediction window can be said to be set such that the predictive power of the current state (e.g., incidents triggered within the lookback window) does not become diminishingly small, which would be the case if the prediction window were set to look farther into the future (e.g., 24 or 48 hours into the future) as the hold time 656 between the lookback window 652 and the prediction window 654 becomes larger and larger. The current state may not have sufficient (if any) predictive power if the hold time 656 is large (e.g., if the prediction window 654 is too separated from the lookback window) and/or if the prediction window 572 is too wide. If the prediction model is used for predicting at an immediate future, then the current state can be said to have a predictive power over the immediate future.

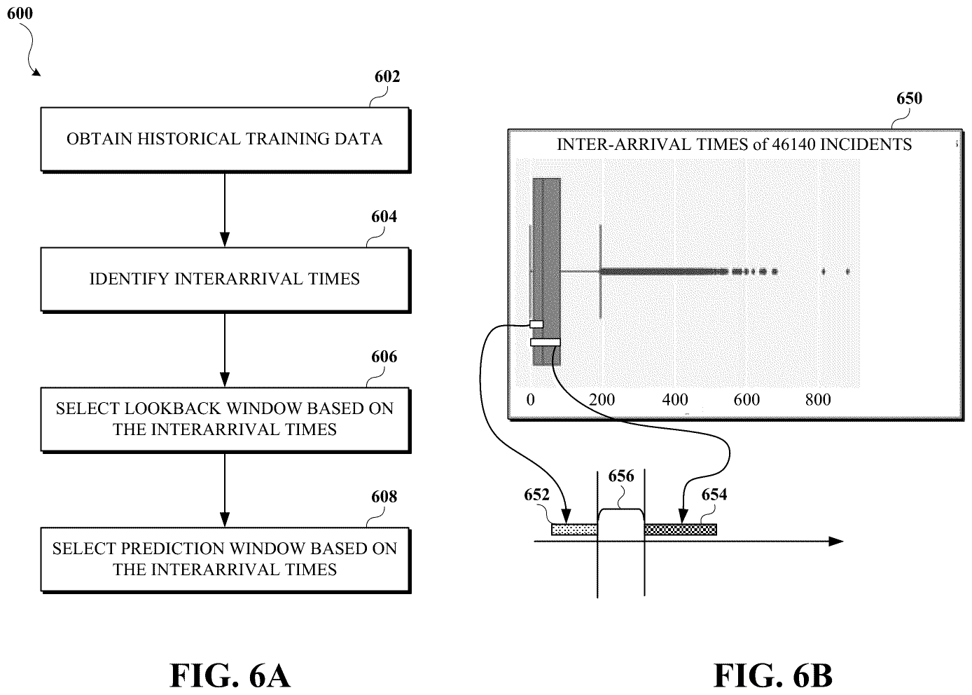

FIG. 7 illustrates an example 700 of identifying temporal association rules during a training phase of an ML model. The ML model is trained to mine (e.g., identify) the temporal associations in the historical training data. To illustrate, the trained model can essentially answer questions such as, “given current incidents, what are likely near future incidents?” Temporal associations of incidents are identified as frequent rules with associated confidences. As becomes clear, the ML model can output multiple predictions per prediction window. Given a current state (e.g., a set of incidents triggered in a lookback window), rules matching the current state are identified and used to generate the predictions.

A bar 702 illustrates that historical data are partitioned according to time units. The bar 702 is illustrated as including 10 time units. However, as can be appreciated, the training data can be divided into significantly many more time units. To illustrate, and without limitations, the training data may span (e.g., may have been collected) over a total duration of 10 minutes. As such, each time slot (e.g., time slots 704A-704J) corresponds to one minute of time and each of the time slots is illustrated as including incidents (e.g., incident types) triggered within the respective one minute. In an example, the length of the time slots can be equal to the selected lookahead window. As illustrated in FIG. 7, the prediction window is twice the size of the lookback window. However, the disclosure is not so limited. The example 700 illustrates that incidents D and E were triggered during the time slot 704A, that incident A was triggered during the time slot 704B, and so on.

Training the ML model proceeds by considering sliding pairs of training windows, such as illustrated in sliding windows 706. A pair of training windows include training current windows and training prediction windows. A training window corresponds to one or more time slots of the bar 702. In the example 700, a training current window is illustrated as including one time slot and a training prediction window is illustrated as including two time slots. Stated another way, the training current window includes all incidents triggered within the time slot(s) corresponding to the training current window; and the training prediction window includes all incidents triggered within the time slot(s) corresponding to the training prediction window.

In FIG. 7, a ratio of 1:2 between the lengths of the current window and the prediction window is used. Other ratios are possible. However, the current window length may necessarily be shorter than the prediction window length, as described above with respect to FIG. 6B. As such, it would be contradictory to set a ratio of 1:1, 2:1, or some other ratio such that the prediction window is smaller than the current window. As such, setting the ratio to 1:3 or some other ratio such that the current window is smaller than the prediction window would be consistent with the teachings herein.

In the sliding windows 706, cells filled with a pattern 708A indicate training current windows and cells filled with a pattern 708B indicate training prediction windows. To illustrate, a sliding window 710A shows that the incidents (e.g., incident templates) D and E occurred in the training current window and that incident A was triggered in a first time slot of the training prediction window and that the incident A was again triggered in a second time slot of the training prediction window; and a sliding window 710B shows that the incidents (e.g., incident templates) B, H, and J occurred in the training current window and that the incidents C and I were triggered in a first time slot of the training prediction window and that the incidents E and F were triggered in a second time slot of the training prediction window.

During the training phase, temporal associations between current and subsequent incidents are inferred (e.g., learnt, extracted, etc.). Mining temporal associations can be summarized as attempting to answer the question “are the incidents of the training current windows predictive of any of the incidents of the training prediction windows?” If the answer is affirmative, then an association rule can be created as long as certain criteria relating to support and/or confidence (further described below) are met. Stated another way, mining temporal associations aims to answer the question, “what is the likelihood of observing an incident in the prediction window based on the incidents in the lookback window?”

To illustrate the process of mining temporal associations, consider the training data, including the sliding windows 710A and 710B. In the case of sliding window 710A, the goal is to determine if incident A is likely to occur during the training prediction windows when incidents D and E have occurred together in the training current window. The mining of temporal associations aims to provide insights into the likelihood of observing incident Abased on the specific combination of incidents D and E in the current window. Similarly, in the context of sliding window 710B, mining temporal associations seeks to answer the question of how likely it is for any of the incidents C, I, E, or F to occur during the training prediction window when the combination of incidents B, H, and J is observed in the training current window. A respective probability (e.g., likelihood) is associated with each of the incidents C, I, E, or F occurring based on the occurrence of the combination of incidents B, H, and J in the current window.

The example 700 is further described with respect to identifying a rule that incident B is predicted to follow incident A (i.e., A⇒B). For ease of visual recognition of the cases where incident A is followed by incident B in sliding windows 706, incidents A and B are shown in rows 712A, 712B, and 712C as being surrounded by brackets, such as “[A]” and “[B].”

Support for the pattern A⇒B is determined. Support indicates the relative frequency of the pattern A⇒B in the historical data. Support can be calculated as the number of occurrences of the pattern A⇒B amongst all of the sliding pairs of windows. In the example 700, there are three (3) occurrences of the pattern A⇒B and the total number of sliding pairs of windows is eight (8). The total number of sliding pairs corresponds to the number of rows in the sliding windows 706. As such, support for the pattern A⇒B is given by Support_{A⇒B}=#(A⇒B)/total=3/8=0.375.

A confidence level in the pattern A⇒B is also determined. The confidence level is indicative of the strength of the association between A and B. The confidence level indicates the conditional probability of observing B given that A has been observed. The confidence can be calculated as a ratio of the number of times that the pattern A⇒B occurred to the number of times that the incident A occurred in training current windows, corresponding to windows filled with pattern the 708A. Symbolically, Confidence_{A⇒B}=P(B|A)=#(A⇒B)/#(A)=3/3=1.

As such, an association rule A⇒B (i.e., if A is the current state, then predict B) can be stored with a confidence level of 1 and a support of 0.375. In an example, only association rules having support values exceeding a support threshold (e.g., 25%) and respective confidence levels exceeding a confidence threshold (e.g., 75%) are used for prediction. That is, during a prediction phase, such as the prediction phase 512 of FIG. 5, if A is observed, then B is predicted based on the rule/pattern A⇒B only if support(A⇒B)≥support_threshold and Confidence(A⇒B)≥confidence_threshold. If a pattern does not occur enough (e.g., support is not greater than the support threshold), then generating a prediction based on the pattern is likely to result in noise and distractions for responders. Similarly, if the confidence level is not sufficiently strong (i.e., does not meet the threshold confidence), then a prediction according to the pattern can also generate noise and distractions for responders.

As another illustration, respective support and confidence levels are also calculated for each of the patterns (B, H, J)⇒C, (B, H, J)⇒I, (B, H, J)⇒E, (B, H, J)⇒E, and (B, H, J)⇒F based on the sliding window 710B. For each of these patterns, support=1/8=0.125 and confidence=1.

For ease of reference, a pattern is said to be composed of an antecedent part and a consequent part. The antecedent part corresponds to the incidents (or services) in a lookback window and the consequent part corresponds to the incidents (or services) predicted to occur in a prediction window. Thus, with respect to the pattern (B, H, J)⇒E, (B, H, J) is the antecedent part and E is the consequent part.

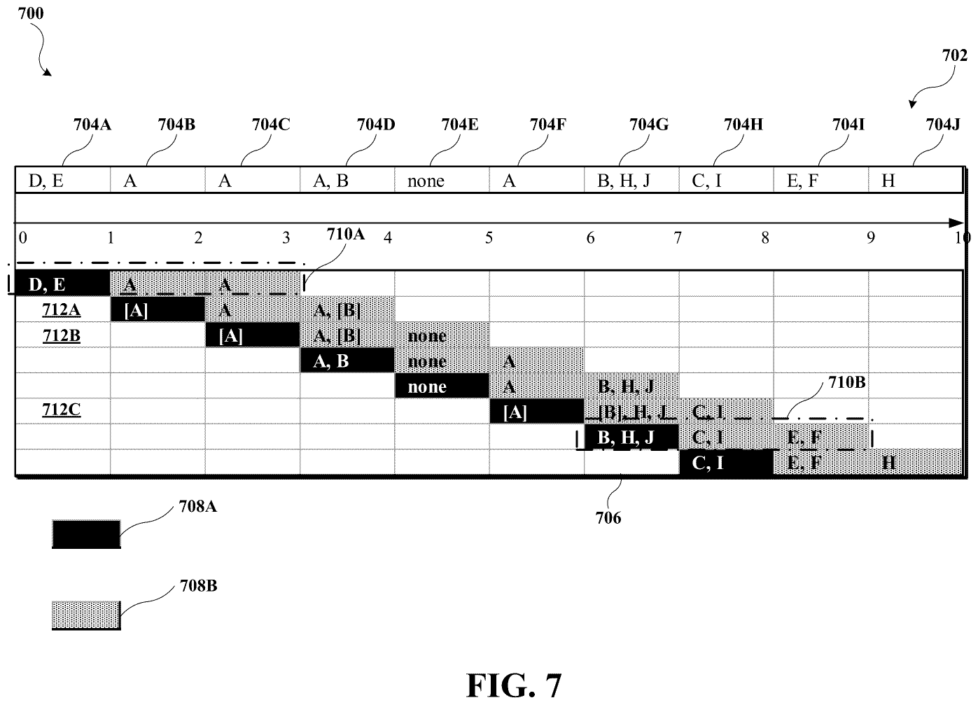

FIG. 8A illustrates an example 800 of predicting which services will trigger incidents. The example 800 illustrates that an EMB (e.g., a data store associated therewith), such as the EMB 400 of FIG. 4, includes prediction rules 802A-802H, which may be derived (e.g., mined) as described above. As can be appreciated, many more prediction rules may have been mined during a training phase as described above. The prediction rules 802A-802H can be associated with, included in, or used by a services prediction model, such as the services prediction module 506 of FIG. 5A.

Each of the prediction rules 802A-802H can be read as follows: if the current state includes services having identifiers given by the antecedent portion (as shown in a column 804), then it can be predicted with the indicated confidence level (as shown in a column 808) that the services with identifiers given by the consequent portion (as shown in a column 806) will trigger incidents in the prediction window. For example, with respect to prediction rule 802A, if the service having an identifier value 90909435 triggered an incident in the lookback window, then there is a 27.01% likelihood (e.g., probability or chance) that the service having the identifier value 89355049 will trigger an incident during the prediction window; and, with respect to prediction rules 802F-802G, If incidents are currently occurring on services {66541000, 90066083}, then next incidents are likely to occur on services 103082618 with probability 0.2647, 66541000 with probability 0.617, and 98554802 with probability 0.102, within the prediction window.

Assuming a confidence threshold of 0.3 (i.e., 30%), then in response to identifying, such as during a prediction phase, that a current state (e.g., a lookback window) includes the service with identifier 90909435, then the prediction rules 802B and 802C will be triggered. As such, the services prediction model can output the service identifiers included in the respective consequent parts. That is, the services prediction model can output 106169891 and 80626266. In an example, the services prediction model can also output the corresponding confidence values.

FIG. 8B illustrates an example 850 of predicting which incidents will be triggered. The example 850 illustrates that an EMB (e.g., a data store associated therewith), such as the EMB 400 of FIG. 4, includes prediction rules 852A-852C. As can be appreciated, many more prediction rules may have been mined during a training phase as described above. The prediction rules 852A-852C can be associated with, included in, or used by an incidents prediction model, such as the incidents prediction model 504 of FIG. 5A.

Each of the prediction rules 852A-852C can be read as follows: if the current state (e.g., the lookback window) includes incidents having identifiers given by the antecedent portion (as shown in a column 854), then it can be predicted with the indicated confidence level (as shown in a column 858) that the incidents with identifiers given by the consequent portion (as shown in a column 856) will be triggered in the prediction window. For example, with respect to prediction rule 852A, if the incident having the identifier value db1d0d6aa7 is triggered in the lookback window, then there is a 54.53% probability that the incident with an identifier value d3859726cd will be triggered during the prediction window.

Incident identifiers can be hash values obtained from textual descriptions of the incidents or incident templates. Manipulating (e.g., comparing) hash values can be faster than comparing long textual strings. A table 860 illustrates examples of hash values. A column 862 includes hash values for corresponding incident templates shown in a column 864.

FIG. 9 is a block diagram of an example 900 illustrating the operations of a template selector. The example 900 may be implemented in the EMB 400 of FIG. 4 or a prediction software therein. The example 900 can be implemented by the incident template selector 502 of FIG. 5. The example 900 includes a template selector 902, which can be, can be included in, or can be implemented by, one of the related-objects identifier software 418A or 418B of FIG. 4 or the prediction software 500 of FIG. 5.

The template selector 902 receives a masked title 904, which may be a masked title of a templated object 908, and outputs a corresponding template 905, if any. The templated object 908 can be any type of object with which a template can be associated. Incidents, alerts, and events are examples of templated objects. The template 905 is associated with the templated object 908. The masked title can be obtained from (e.g., generated by, etc.) a pre-processor 910, which can receive the templated object 908 or a title 906 of the templated object and outputs the masked title 904. The masked title 904 can be associated with the templated object 908. In some examples, the title 906 may not be pre-processed and the template selector 902 can identify the template 905 for the templated object 908 based on the title 906 (instead of based on the masked title 904). In an example, the pre-processor 910 can be part of, or included in, the template selector 902. As such, the template selector 902 can receive the templated object 908 (of a title therefor), pre-process the title to obtain the masked title and then obtain the template 905 based on the masked title.

Each templated object can have an associated title. The title 906 of the templated object 908 may be or may be derived from another object that may be associated with or related to the templated object 908. While the description herein may use an attribute of a templated object that may be named “title” and refers to a “masked title,” the disclosure is not so limited. Broadly, a title can be any attribute, a combination of attributes, or the like that may be associated with a templated object and from which a corresponding masked string can be obtained.

For brevity, that the template selector 902 receives the templated object 908 encompasses at least one or a combination of the following scenarios. That the template selector 902 receives the templated object 908 can mean, in an implementation, that the template selector 902 receives the templated object 908 itself. That the template selector 902 receives the templated object 908 can mean, in an implementation, that the template selector 902 receives the masked title 904 of the templated object 908. That the template selector 902 receives the templated object 908 can mean, in an implementation, that the template selector 902 receives the title 906 of the templated object 908. That the template selector 902 receives the templated object 908 can mean, in an implementation, that the template selector 902 receives a title or a masked title of an object related to the templated object 908.

The pre-processor 910 may apply any number of text processing (e.g., manipulation) rules to the title of the templated object 908 to obtain the masked title. It is noted that the title is not itself changed as a result of the text processing rules. As such, stating that a rule X is applied to the title (such as the title of the templated object), or any such similar statements, should be understood to mean that the rule X is applied to a copy of the title. The text processing rules are intended to remove sub-strings that should be ignored when generating/identifying templates, which is further described below. For effective template generation (e.g., to obtain optimal templates from titles), it may be preferable to use readable strings (e.g., strings that include words) as inputs to the template generation algorithm. However, titles may not only include readable words. Titles may also include symbols, numbers, or letters. As such, before processing a title through any template generation or template identifying algorithm, the title can be masked to remove some substrings, such as symbols or numbers, to obtain an interpretable string (e.g., a string that is semantically meaningful to a human reader).

To illustrate, and without limitations, assume that a first templated object has a first title “CRITICAL—ticket 310846 issued” and that a second templated object has a second title “CRITICAL—ticket 310849 issued.” The first and the second titles do not match without further text processing. However, as further described herein, the first and the second titles may be normalized to the same masked title “CRITICAL—ticket <NUMBER> issued.” As such, for purposes of identifying similar incidents, the first templated object and the second templated object can be considered to be related.

A set of text processing rules may be applied to a title to obtain a masked title. In some implementations, more, fewer, other rules than those described herein, or a combination thereof may be applied. The rules may be applied in a predefined order.

A first rule may be used to replace numeric substrings, such as those that represent object identifiers, with a placeholder. For example, given the title “This is ticket 310846 from Technical Support,” the first rule can provide the masked title “This is ticket <NUMBER> from Technical Support,” where the numeric substring “310846” is replaced with the placeholder “<NUMBER>.” A second rule may be used to replace substrings identified as measurements with another placeholder. For example, given the title “Disk is 95% full in lt-usw2-dataspeedway on host:lt-usw2-dataspeedway-dskafka-03,” the second rule can provide the masked title “Disk is <MEASUREMENT> full in lt-usw2-dataspeedway on host:lt-usw2-dataspeedway-dskafka-03,” where the substring “95%” is replaced with the placeholder “<MEASUREMENT>.”

The text processing rules may be implemented in any number of ways. For example, each of the rules may be implemented as a respective set of computer executable instructions (e.g., a program, etc.) that carries out the function of the rule. At least some of the rules may be implemented using pattern matching and substitution, such as using regular expression matching and substitution. Other implementations are possible.

The template selector 902 uses a template data 912, which can include templates used for matching. The template selector 902 identifies the template 905 of the template data 912 that matches the templated object 908 (or a title or a matched title, as the case may be, depending on the input to the template selector 902).

A template updater 914 can be used to update the template data 912. The template data 912 can be updated according to update criteria. In an example, templated objects received within a recent time window can be used to update the template data 912. In an example, the recent time window can be 10 seconds, 15 seconds, 1 minute, or some other recent time window. In an example, the template data 912 is updated after at least a certain number of new templated objects are created in the EMB 400 of FIG. 4. Other update criteria are possible. For example, the template data of different routing keys or of different managed organizations can be updated according to different update criteria.

In an example, the template updater 914 can be part of the template selector 902. As such, in the process of identifying templates for templated objects received within the recent time window, new templates may be added to the template data 912. Said another way, in the process of identifying a type of a templated object (based on the title or the masked title, as the case may be), if a matching template is identified, that template is used; otherwise, a new template may be added to the template data 912.

FIG. 10 illustrates examples 1000 of templates. Templates can be obtained from titles or masked titles, as the case may be. FIG. 10 illustrates three templates; namely templates 1002-1006. The templates 1002, 1004, 1006 may be derived from (i.e., at template update time) or may match (i.e., at classification time) the title groups 1008, 1010, 1012, respectively.

As mentioned above, templates include constant parts and variable parts. The constant parts of a template can be thought of as defining or describing, collectively, a distinct state, condition, operation, failure, or some other distinct semantic meaning as compared to the constant parts of other templates. The variable parts can be thought of as defining or capturing a dynamic, or variable state to which the constant parts apply.

To illustrate, the template 1002 includes, in order of appearance in the template, the constant parts “No,” “kafka,” “process,” “running,” and “in;” and includes variable parts 1014 and 1016 (represented by the pattern <*> to indicate substitution patterns). The variable part 1014 can match or can be derived from substrings 1018, 1022, 1026, and 1030 of the title group 1008; and the variable part 1016 can match or can be derived from substrings 1020, 1024, 1028, and 1032 of the title group 1008. The template 1004 does not include variable parts. However, the template 1004 includes a placeholder 1034, which is identified from or matches a mask of numeric substrings 1036 and 1038, as described above. The template 1006 includes a placeholder 1040 and variable parts 1042, 1044. The placeholder 1040 can result from or match masked portions 1046 and 1048. The variable part 1042 can match or can be derived from substrings 1050 and 1052. The variable part 1044 can match or can be derived from substrings 1054 and 1056.

In obtaining templates from titles or masked titles, as the case may be, such as by the template updater 914 of FIG. 9, it is desirable that the templates include a balance of constant and variable parts. If a template includes too many constant parts as compared to the variable parts, then the template may be too specific and would not be usable to combine similar titles together into a group or cluster for the purpose of classification. Such a template can result in false negatives (i.e., unmatched titles that should in fact be identified as similar to other titles). If a template includes too many variable parts as compared to the constant parts, then the template can practically match titles even though they are not in fact similar. Such templates can result in many false positive matches.

To illustrate, given the title “vednssoa04.atlqa1/keepalive: No keepalive sent from client for 2374 seconds (>=120),” a first algorithm may obtain a first template “vednssoa04.atlis1/keepalive: No keepalive sent from client for <*> seconds <*>,” a second algorithm may obtain a second template “<*>: <*><*><*><*> client <*><*><*><*>,” and a third algorithm may obtain a third template “<*>: No keepalive sent from client for <*> seconds <*>.” The first template capturers (includes) very few parameters as compared to the constant parts. The second template includes too many parameters. The third template includes a balance of constant and variable parts.

The template selector 902 can be implemented in any number of ways. In an example, a log-parsing technique or algorithm can be used to obtain templates from templated objects. In an implementation, the technique or algorithm used can be an off-line technique or algorithm in which obtaining templates to match against and matching titles to templates are separate steps (e.g., separated in time) where obtaining additional templates can be a batch off-line process. In an implementation, the technique or algorithm used can be an on-line technique or algorithm in which an initial set of templates may be obtained using a batch process and new templates are obtained from titles received for matching in real-time or in near real-time.

As described with respect to FIG. 9, in the case of an off-line processor (parser) the template updater 914 may be separate from the template selector 902; and in the case of an on-line processor (parser), the template updater 914 may be part or, combined with, or works in conjunction with the template selector 902. As such, responsive to new templated data (i.e., titles or masked titles therefor) received at the template selector 902 therein of FIG. 9, the template data 912 can be recalculated (e.g., regenerated or updated) by (e.g., according to, to incorporate, etc.) any new templated data. As such, the template selector 902 not only applies existing templates of the template data 912 for matching, the template selector 902 can also update the template data 912 to include new templates, which may be influenced by the templated data (or a subset thereof).

In an example, obtaining the template may be delayed (e.g., deferred) for a short period of time until the template data 912 is updated based on most recently received templated objects according to an update criterion. The update criterion can be time based (i.e., a time-based criterion), count based (i.e., a count-based criterion), other update criterion, or a combination thereof. In example, the update criterion may be or may include updating the template data 912 at a certain time frequency (e.g., every 15 seconds or some other frequency). In example, the update criterion may be or may include updating the template data 912 after a certain number of new templated objects are received (e.g., every 100, 200, more or fewer new templated objects are received). In an example, if the count-based criterion is not met within a threshold time, then the template data 912 is updated according the new templated objects received up to the expiry of the threshold time. To illustrate, and without limitations, assume that the update criterion is set to be or equivalent to “every 75 new objects” and that a new templated object is the 56^{th} object received in the update window. A template is not obtained for this templated object until after the 75^{th} templated object is received and the template data 912 is updated using the 75 new objects.

Examples of techniques or algorithms that may be used include, but are not limited to using well known techniques such as regular expression parsing, Streaming structured Parser for Event Logs using Longest common subsequence (SPELL), Simple Logfile Clustering Tool (SLECT), Iterative Partitioning Log Mining (IPLoM), Log File Abstraction (LFA), Depth tRee bAsed onlIne log parsiNg (DRAIN), or other similar techniques or algorithms. At least some of these algorithms or techniques are machine learning techniques that use unsupervised learning to learn (e.g., incorporate) new templates in their respective models based on new received data. In an example, DRAIN may be used. A detailed description of DRAIN or any of the other algorithms is not necessary as a person skilled in the art is, or can easily become, familiar with log parsing techniques, including DRAIN, which is a machine learning model that uses unsupervised learning.

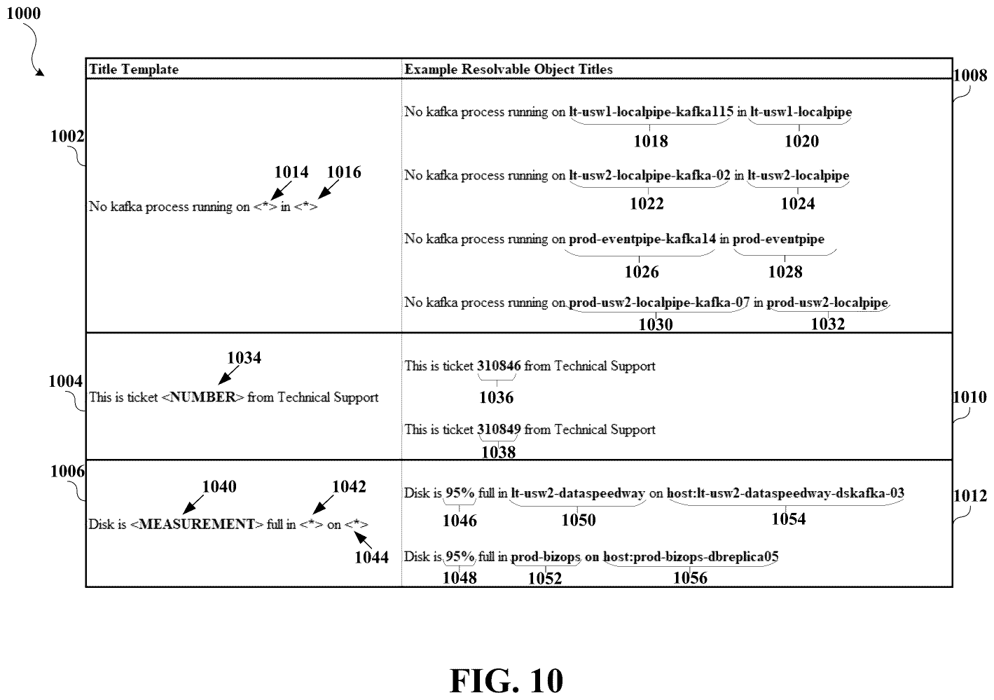

FIG. 11 is a flowchart of a technique 1100 for incident prediction. The technique 1100 can be implemented, for example, as a software program that may be executed by a computing device such as the network computer 300 of FIG. 3. The software program can include machine-readable instructions that may be stored in a memory such as one or more of the memory 304, the processor-readable stationary storage device 334, or the processor-readable removable storage device 336 of FIG. 3, and that, when executed by a processor, such as the processor 302 of FIG. 3, may cause the computing device to perform the technique 1100. The technique 1100 can be implemented using specialized hardware or firmware. Multiple processors, memories, or both, may be used.

At 1102, a current state that includes incidents occurring in a lookback window are identified. The lookback window can be the lookback window 570 of FIG. 5B. Incidents occurring in the lookback window means incidents triggered during the lookback window.

At 1104, predicted incidents likely to occur in a prediction window based on the current state are identified. The prediction window can be the prediction window 572 of FIG. 5B. Identifying predicted incidents encompasses identifying incident templates of incidents likely to occur in the prediction window. As described above, the predicted incidents can be identified using an ML model (e.g., the incidents prediction module 504 of FIG. 5A) that is trained to identify temporal associations between historically occurring incidents, a length (i.e., a duration) of the lookback window, and a length (i.e., a duration) of the prediction window.

Identifying the predicted incidents likely to occur in the prediction window based on the current state can include identifying an association rule that includes an antecedent part, a consequent part, and a likelihood score. The association rule can be a prediction rule, such as described with respect to FIG. 8B. As such, the antecedent part can be or include the incidents occurring in the lookback window, and the consequent part can be or include the predicted incidents. The predicted incidents are then selected in response to the likelihood score meeting a predefined confidence threshold.

As described above with respect to FIG. 7, the ML model can be trained by dividing the historically occurring incidents according to time slots. Consecutive time slots can be grouped into sliding windows. Each sliding window can include at least one of the time slots as training current windows and at least one time slots as training prediction windows. The association rule is then identified based on the sliding windows. Identifying the association rule based on the sliding windows can include identifying a support for the association rule based on a number of occurrences of the antecedent part and the consequent part in the sliding windows. Identifying the association rule based on the sliding windows can additionally or alternatively include identifying a confidence level for the association rule based on a ratio of a number of the sliding windows where the antecedent part is followed by the consequent part to a number of training current windows that include the antecedent part.

As described with respect to FIGS. 6A-6B, the lookback window can be based on a first threshold related to interarrival times of the historically occurring incidents, and the prediction window can be based on a second threshold related to the interarrival times of the historically occurring incidents. The first threshold can be different from the second threshold. In an example, the first threshold can be the 50^{th} percentile of the interarrival times, and the second threshold can be the 75^{th} percentile of the interarrival times.

At 1106, a notification with respect to at least one of the predicted incidents can be transmitted. In an example, the notification can be transmitted to a responder assigned to at least one of the incidents that occurred in the lookback window. To illustrate, and without limitations, the notification may essentially state, “an incident corresponding to the template ‘CRITICAL—ticket <NUMBER> issued’ is likely to be triggered in the next 10 minutes,” where 10 minutes is the prediction window. In an example, the notification may also include the incidents occurring in a lookback window.

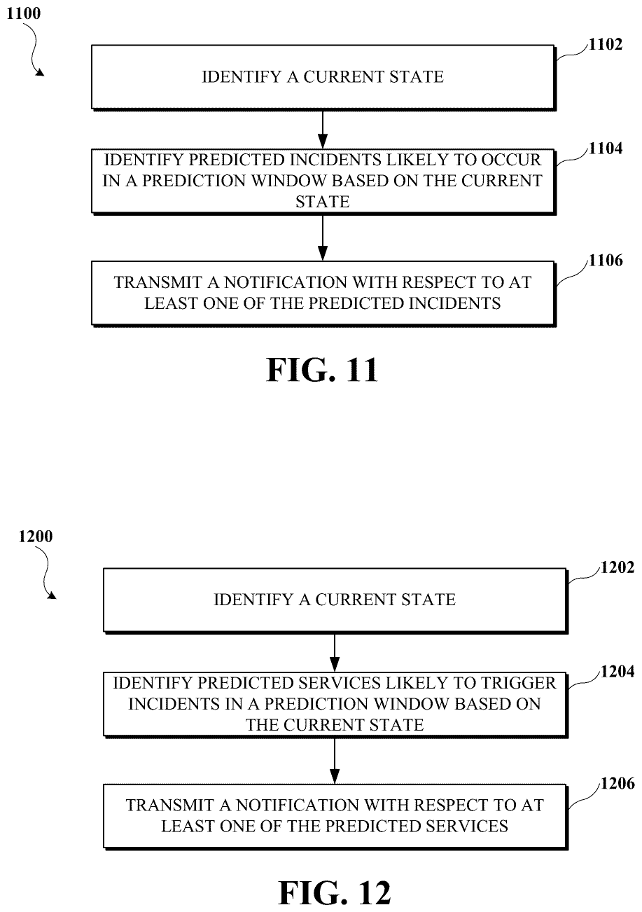

FIG. 12 is a flowchart of a technique 1200 for service prediction. The technique 1200 can be implemented, for example, as a software program that may be executed by a computing device such as the network computer 300 of FIG. 3. The software program can include machine-readable instructions that may be stored in a memory such as one or more of the memory 304, the processor-readable stationary storage device 334, or the processor-readable removable storage device 336 of FIG. 3, and that, when executed by a processor, such as the processor 302 of FIG. 3, may cause the computing device to perform the technique 1200. The technique 1200 can be implemented using specialized hardware or firmware. Multiple processors, memories, or both, may be used.

At 1202, a current state that includes services that triggered incidents in a lookback window are identified. The lookback window can be the lookback window 570 of FIG. 5B. At 1204, predicted services likely to trigger incidents in a prediction window based on the current state are identified. The prediction window can be the prediction window 572 of FIG. 5B. As described above, the predicted services can be identified using an ML model (e.g., the services prediction module 506 of FIG. 5A) that is trained to identify temporal associations between historically triggering services, a length (i.e., a duration) of the lookback window, and a length (i.e., a duration) of the prediction window.

Identifying the predicted services likely to trigger incidents in the prediction window based on the current state can include identifying an association rule that includes an antecedent part, a consequent part, and a likelihood score. The association rule can be a prediction rule, such as described with respect to FIG. 8A. As such, the antecedent part can be or include the services that triggered incidents in a lookback window, and the consequent part can be or include the predicted services. The predicted services are then selected in response to the likelihood score meeting a predefined confidence threshold. The ML model can be trained as described with respect to FIG. 7 and as described with respect to FIG. 11.

As described with respect to FIGS. 6A-6B, the lookback window can be based on a first threshold related to interarrival times of historically occurring incidents triggered by the historically incident triggering services, and the prediction window can be based on a second threshold related to the interarrival times. The first threshold can be different from the second threshold. In an example, the first threshold can be the 50^{th} percentile of the interarrival times, and the second threshold can be the 75^{th} percentile of the interarrival times.

At 1206, a notification with respect to at least one of the predicted incidents can be transmitted. To illustrate, and without limitations, the notification may essentially state, “an incident is likely to be triggered by the service <service name> in the next 10 minutes,” where 10 minutes is the prediction window and <service name> can be substituted by the service, which can be looked up, such as in the data store 410 of FIG. 10, based on a service identifier.

In an example, the notification can be transmitted to a responder assigned to an incident triggered by a service included in the current state. In an example, transmitting the notification with respect to at least one of the predicted services can include identifying a responder associated with one of the predicted services and transmitting the notification to the responder. In an example, the notification can be transmitted to a responder or a team of responders identified as an owner (e.g., responsible for) the service that is likely to trigger. In an example, an incident triggered by the predicted service in the prediction window can be assigned to a responder assigned an incident triggered by one of the services that triggered incidents in the lookback window. That is, instead of assigning incidents to owners of the predicted services, the incidents are assigned to the owner(s) of the services that are identified as likely to cause the triggering of the incidents.

In another implementation, a current state that includes incidents occurring in a lookback window are identified. Predicted incidents likely to occur in a prediction window are identified using an incidents prediction model. The incidents prediction model is trained to identify temporal associations between historically occurring incidents, a length of the lookback window, and a length of the prediction window. Predicted services likely to trigger the predicted incidents in the prediction window are also identified. An incident triggered by one of the predicted services is assigned to a responder assigned to one of the incidents occurring in the lookback window rather than (or in addition to) to a responder that owns the one of the predicted services.

For simplicity of explanation, the processes and techniques, such as the techniques 600, 1100, and 1200 of FIGS. 6, 11, and 12 respectively, are each depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of this disclosure.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “software” refers to logic embodied in hardware or software instructions, which can be written in a programming language, such as C, C++, Objective-C, COBOL, Java™, PUP, Perl, JavaScript, Ruby, VBScript, Microsoft .NET™ languages such as C#, and/or the like. A software may be compiled into executable programs or written in interpreted programming languages. Software may be callable from other software or from themselves. Any software described herein refers to one or more logical modules that can be merged with other software or applications, or can be divided into sub-software or tools. The software can be stored in non-transitory computer-readable medium or computer storage devices and be stored on and executed by one or more general purpose computers, thus creating a special purpose computer configured to provide the software.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
identifying a current state comprising incidents occurring in a lookback window;
identifying predicted incidents likely to occur in a prediction window based on the current state,
wherein the predicted incidents are identified using a machine learning model that is trained to identify temporal associations between historically occurring incidents, a length of the lookback window, and a length of the prediction window; and
transmitting a notification with respect to at least one of the predicted incidents.

2. The method of claim 1, wherein identifying the predicted incidents likely to occur in the prediction window based on the current state comprises:
identifying an association rule comprising an antecedent part, a consequent part, and a likelihood score,
wherein the antecedent part consists of the incidents occurring in the lookback window, and the consequent part consists of the predicted incidents; and
selecting the predicted incidents in response to the likelihood score meeting a confidence threshold.

3. The method of claim 2, further comprising:
training the machine learning model by:
dividing the historically occurring incidents according to time slots;
grouping consecutive time slots into sliding windows, wherein each sliding window comprises at least one of the time slots as a training current window and at least another of the time slots as a training prediction window; and
identifying the association rule based on the sliding windows.

4. The method of claim 3, wherein identifying the association rule based on the sliding windows comprises:
identifying a support for the association rule based on a number of occurrences of the antecedent part and the consequent part in the sliding windows.

5. The method of claim 3, wherein identifying the association rule based on the sliding windows comprises:
identifying a confidence level for the association rule based on a ratio of a number of the sliding windows where the antecedent part is followed by the consequent part to a number of training current windows that include the antecedent part.

6. The method of claim 1, wherein the lookback window is based on a first threshold related to interarrival times of the historically occurring incidents, and the prediction window is based on a second threshold related to the interarrival times of the historically occurring incidents.

7. The method of claim 6, wherein the first threshold is different from the second threshold.

8. The method of claim 6, wherein the first threshold corresponds to a 50^{th} percentile of the interarrival times, and wherein the second threshold corresponds to a 75^{th} percentile of the interarrival times.

9. A method, comprising:
identifying a current state comprising services that triggered incidents in a lookback window;
identifying predicted services likely to trigger incidents in a prediction window based on the current state,
wherein the predicted services are identified using a machine learning model that is trained to identify temporal associations between historically incident triggering services, a length of the lookback window, and a length of the prediction window; and
transmitting a notification with respect to at least one of the predicted services.

10. The method of claim 9, wherein identifying the predicted services likely to trigger incidents in the prediction window based on the current state comprises:
identifying an association rule comprising an antecedent part, a consequent part, and a likelihood score,
wherein the antecedent part consists of the services that triggered incidents in the lookback window, and the consequent part consists of the predicted services; and
selecting the predicted services in response to the likelihood score meeting a confidence threshold.

11. The method of claim 10, further comprising:
training the machine learning model by:
dividing the historically incident triggering services according to time slots;
grouping consecutive time slots into sliding windows, wherein each sliding window comprises at least one of the time slots as a training current window and at least another of time slots as a training prediction window; and
identifying the association rule based on the sliding windows.

12. The method of claim 11, wherein identifying the association rule based on the sliding windows comprises:
identifying a support for the association rule based on a number of occurrences of the antecedent part and the consequent part in the sliding windows.

13. The method of claim 11, wherein identifying the association rule based on the sliding windows comprises:
identifying a confidence level for the association rule based on a ratio of a number of the sliding windows where the antecedent part is followed by the consequent part to a number of training current windows that include the antecedent part.

14. The method of claim 9, wherein the lookback window is based on a first threshold related to interarrival times of historically occurring incidents triggered by the historically incident triggering services, and the prediction window is based on a second threshold related to the interarrival times.

15. The method of claim 14, wherein the first threshold is different from the second threshold.

16. The method of claim 14, wherein the first threshold corresponds to a 50^{th} percentile of the interarrival times, and wherein the second threshold corresponds to a 75^{th} percentile of the interarrival times.

17. The method of claim 9, wherein transmitting the notification with respect to at least one of the predicted services comprises:
transmitting the notification to a responder assigned to an incident triggered by a service included in the current state.

18. The method of claim 9, wherein transmitting the notification with respect to at least one of the predicted services comprises:
identifying a responder associated with one of the predicted services; and
transmitting the notification to the responder.

19. The method of claim 9, further comprising:
assigning an incident triggered by one of the predicted services in the prediction window to a responder assigned an incident triggered by one of the services that triggered incidents in the lookback window.

20. A device, comprising:
one or more memories; and
one or more processors, the one or more processors configured to execute instructions stored in the one or more memories to:
identify a current state comprising incidents occurring in a lookback window;
identify, using an incidents prediction model, predicted incidents likely to occur in a prediction window, wherein the incidents prediction model is trained to identify temporal associations between historically occurring incidents, a length of the lookback window, and a length of the prediction window;
identify, using a services prediction model, predicted services likely to trigger the predicted incidents in the prediction window; and
assign an incident triggered by one of the predicted services to a responder assigned to one of the incidents occurring in the lookback window.
